(19) United States
(12) Patent Application Publication
(10) Pub. No.: US 2010/0248086 A1
(43) Pub. Date: Sep. 30, 2010

(54) Method of Evaluating the Performance of Fuel Cell Cathode Catalysts, Corresponding Cathode Catalysts and Fuel Cell

(75) Inventors: Kunihiro Nobuhara, Aichi (JP); Hideaki Kasai, Osaka (JP); Hiroshi Nakanishi, Osaka (JP); Wilson Agerico Tan Dino, Osaka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, Toyota-shi, Aichi (JP)

(21) Appl. No.: 12/294,900

(22) PCT Filed: Mar. 28, 2007
(86) PCT No.: PCT/JP2007/057517

§ 371 Date: Sep. 26, 2008

(30) Foreign Application Priority Data
Mar. 30, 2006 (JP) 2006-093546

(51) Int. Cl. H01M 4/92; H01M 4/36; G06F 19/00

(52) U.S. Cl. 429/524; 429/523; 702/30

(57) ABSTRACT

A method for accurately evaluating the performance of fuel-cell electrode catalysts, a method of search for fuel-cell electrode catalysts having excellent performance, and fuel-cell electrode catalysts having new and excellent catalytic activity searched for by the above method. In a method for evaluating the performance of fuel-cell electrode catalysts composed of conductive carriers on which catalytic metal is supported, the oxygen atom adsorption energy on the catalytic metal surface obtained through a molecular simulation analysis is used as an indicator of the performance evaluation. Suitable catalysts consist of Pt—Au or Pt—Au—B, wherein B is one or more metal chosen from the group of chrome (Cr), manganese (Mn), iron (Fe), cobalt (Co), nickel (Ni), rhodium (Rh) and palladium (Pd) and wherein the content of Au is 6 atom % or less.

### TECHNICAL FIELD

The present invention relates to a method of evaluating the performance of battery electrode catalysts, a method of search for battery electrode catalysts, fuel-cell electrode catalysts superior in catalytic activity searched for by the search method, and fuel cells having such electrode catalysts.

### BACKGROUND ART

A fuel cell is drawing attention as a clean power generation system having little adverse influences on the global environment since a product due to its cell reaction is water in principle. For example, a polymer electrolyte fuel cell obtains electromotive force by providing both surfaces of a proton-conducting solid polymer electrolyte membrane with a pair of electrodes, supplying hydrogen gas as a fuel gas to one electrode (fuel electrode: anode), and supplying oxygen gas or air as an oxidant to the other electrode (air electrode: cathode).

Properties of such polymer electrolyte fuel cell have been greatly improved due to the following reasons: (1) a polymer electrolyte membrane having high ionic conductivity has been developed; (2) the reaction site has been made three-dimensional in a so-called catalyst layer by using, as a constituent material of the electrode catalyst layer, a catalyst-supporting carbon covered with ion-exchange resin (polyelectrolyte) of a type identical to or different from the polymer electrolyte membrane; and the like. In addition to such high cell properties, since the polymer electrolyte fuel cell can be easily made smaller and lighter, the practical application thereof to a power supply for a mobile vehicle, such as an electric vehicle, or for a small cogeneration system, for example, is expected.

Generally, an electrode having gas diffusivity used in the polymer electrolyte fuel cell is composed of a catalyst layer including the above catalyst-supporting carbon covered with ion-exchange resin and a gas diffusion layer for supplying reactant gas to this catalyst layer and for collecting electrons. Further, void portions composed of pores formed between secondary or tertiary particles of the carbon as a constituent material exist in the catalyst layer, and the void portions function as diffusion channels for the reactant gas. Furthermore, a noble metal catalyst that is stable in ion-exchange resin, such as platinum or platinum-alloy, is generally used as the above catalyst.

Conventionally, a catalyst in which noble metal, such as platinum or platinum-alloy, is supported on carbon black is used for cathode and anode electrode catalysts in the polymer electrolyte fuel cell. Platinum-supporting carbon black is generally prepared by adding sodium bisulfite to chloroplatinic acid aqueous solution, allowing the mixture to react with hydrogen peroxide solution, allowing carbon black to support the produced platinum colloid, and, after washing, treating the mixture with heat according to need. Electrodes of the polymer electrolyte fuel cell are manufactured by dispersing the platinum-supporting carbon black in a polymer electrolyte solution so as to prepare ink, and applying the ink to gas diffusion substrates such as carbon papers, followed by drying. The electrolyte membrane-electrode assembly (MEA) is composed by sandwiching the polymer electrolyte membrane between these two electrodes for hot-pressing.

Since platinum is an expensive noble metal, it is hoped that sufficient performance can be achieved with a small amount of platinum supported. For this reason, an approach to enhancing catalytic activity with a smaller amount of platinum is being considered. For example, JP Patent Publication (Kokai) No. 2003-77481 A discloses that the amount of catalyst material used can be reduced as compared with conventional technologies by using an X-ray diffraction measurement value of catalyst material on an electrode surface as a parameter, since high catalytic activity is obtained when the measurement value is in a specific range. According to the above invention, the ratio (I (111)/ II (200)) of peak intensity I of the plane (111) to peak intensity II of the plane (200) based on the X-ray diffraction of catalytic metal microparticles is 1.7 or less.

Further, for the purpose of providing a fuel-cell electrode catalyst that suppresses the development of platinum particles during operation and that has high durability performance, JP Patent Publication (Kokai) No. 2002-289208 A discloses an electrode catalyst composed of a conductive carbon material, metal particles that are supported on the conductive carbon material and that are more resistant to oxidation than platinum under acidic conditions, and platinum with which the outer surfaces of the metal particles are covered. Specifically, the publication discloses examples of an alloy in the form of metal particle composed of at least one kind of metal selected from gold, chrome, iron, nickel, cobalt, titanium, vanadium, copper, and manganese, and platinum.

In the polymer electrolyte fuel cell, hydrogen-containing gas (fuel gas) is used as an anode reactant gas, and oxygen-containing gas, such as air, is used as a cathode reactant gas. In such case, electrode reactions expressed by the following formulas (1) and (2) proceed in the anode and the cathode, respectively, and the entire cell reaction expressed by the formula (3) proceeds as a whole, whereby electromotive force is generated.

H₂→2H⁺+2e⁻ (1)

(½)O₂+2H⁺+2e⁻→H₂O (2)

H₂+(½)O₂→H₂O (3)

However, such a conventional polymer electrolyte fuel cell is problematic in that it cannot obtain high cell output, since an activation overpotential of the oxygen reduction reaction expressed by the formula (2) is much larger than that of the hydrogen oxidation reaction expressed by the above formula (1).

In JP Patent Publication (Kokai) No. 2002-15744 A, for the purpose of obtaining excellent cathodic polarization characteristics and high cell output, the polarization characteristics of the cathode are improved by allowing the cathode catalyst layer to contain a metal complex having a predetermined amount of iron or chrome, in addition to a metal catalyst selected from the group composed of platinum and platinum-alloy. Specifically, it discloses a polymer electrolyte fuel cell composed of an anode, a cathode, and a polymer electrolyte membrane disposed between the anode and the cathode, and the cathode includes a gas diffusion layer and a catalyst layer disposed between the gas diffusion layer and the polymer electrolyte membrane. The catalyst layer includes: a noble metal catalyst selected from the group composed of platinum and platinum-alloy; and the metal complex containing iron or chrome, and the amount of the metal complex is 1 to 40% by mole with respect to the total amount of the metal complex and noble metal catalyst. Thus, the metal complex having iron or chrome contained in the catalyst layer of the cathode can effectively reduce the activation overpotential of the cathode oxygen reduction reaction expressed by the formula (2), and as a result, the cathodic polarization characteristics can be improved, whereby high cell output can be obtained.

In J. of the Electrochemical Society, 146 (10) 3750-3756 (1999), various catalytic metals or catalytic alloys, such as Pt, Pt—Ni, Ni, Pt—Co, and Pt—Fe, are synthesized, so as to evaluate the performance as fuel-cell electrode catalysts. In this publication, the performance of Pt—Ni, Pt—Co, Pt—Fe, and the like with respect to various composition ratios are evaluated by using an RDE (rotating disc electrode).

### SUMMARY OF THE INVENTION

### Problems to be Solved by the Invention

Attempts to use electrode catalyst or a fuel cell using such electrode catalyst, particularly a polymer electrolyte fuel cell and the like, as an automobile power supply or stationary power supply, are being made. While it is important to improve cell performance, it has been strongly demanded to maintain a desired power generation performance over a long period of time. Further, the performance thereof is particularly strongly demanded since expensive noble metal is used. Particularly, since the oxygen reduction overpotential of the oxygen reduction electrode is large, dissolution or reprecipitation of platinum is a major cause of reducing fuel-cell efficiency in high voltage environments.

However, as represented by the above Patent Documents and Non-patent Document, existing research is merely directed to improve catalytic activity, and sufficient evaluation of catalytic activity is not conducted. Further, while the performance evaluation disclosed in J. of the Electrochemical Society is interesting in terms of knowing the performance of a fuel-cell electrode catalyst, such evaluation is insufficient for evaluating future metals or alloys that are effective as fuel-cell electrode catalysts in advance and using such evaluation for the development of catalyst.

Thus, it is an object of the present invention to develop a method of accurately evaluating the performance of fuel-cell electrode catalysts, a method of search for fuel-cell electrode catalysts having excellent performance, and specifically obtaining fuel-cell electrode catalysts having new and excellent catalytic activity searched for by the above method.

### Means of Solving the Problems

The present inventors have found that oxygen atom adsorption energy on a catalytic metal surface obtained through a molecular simulation analysis is the most suitable as an indicator of evaluating the performance of the fuel-cell electrode catalyst, and thus achieved the present invention.

Namely, in a first aspect, the present invention is an invention of a method of evaluating the performance of a fuel-cell electrode catalyst composed of conductive carbon on which catalytic metal is supported. The oxygen atom adsorption energy on the catalytic metal surface obtained through the molecular simulation analysis is used as an indicator of the performance evaluation.

In the performance evaluation method of the present invention, specifically, it is preferable that the catalytic metal is selected such that the oxygen atom adsorption energy is between 0.18 to 1.05 eV, it is more preferable that the catalytic metal is selected such that the oxygen atom adsorption energy is between 0.20 and 0.85 eV, and it is even more preferable that the catalytic metal is selected such that the oxygen atom adsorption energy is between 0.30 and 0.60 eV.

As used herein, “the oxygen atom adsorption energy on the catalytic metal surface obtained through the molecular simulation analysis” is obtained by a calculation method referred to as “first-principles electronic structure calculation.” A specific calculation model used in the present invention is as follows:

(1) A catalytic noble metal is modeled with four layers (one layer contains four metal atoms). Note that since calculation is carried out under periodic boundary conditions, the metal surface (XY directions) infinitely extends. Namely, an actual metal surface is simulated with four metal atoms. Regarding the z-direction, a four-layer thin membrane is not modeled, but it is assured that an actual metal surface is simulated with four layers.
(2) An alloy is modeled by changing the atomic ratio such that the ratio corresponds to that of the composition of a measured catalyst alloy.
(3) Since stable sites in the vicinity of the surface differ depending on alloying elements, the stable sites are identified through the same calculation, so as to establish an alloy model.
(4) A difference in energy per oxygen atom between a state in which oxygen atoms are stably adsorbed onto the alloy surface and a state in which oxygen atoms are infinitely separate from the alloy surface and are in the form of oxygen molecules is calculated as the oxygen atom adsorption energy.

In a second aspect, the present invention is an invention in which the above indicator is used for search for a novel, high-performance fuel-cell electrode catalyst. Namely, it is a method of search for a fuel-cell electrode catalyst composed of a conductive carrier on which catalytic metal is supported. The method characteristically uses the oxygen atom adsorption energy on the catalytic metal surface obtained through the molecular simulation analysis as an indicator of the performance evaluation.

Specifically, it is preferable to search for a catalytic metal having an oxygen atom adsorption energy of 0.18 to 1.05 eV, it is more preferable to search for a catalytic metal having an oxygen atom adsorption energy of 0.20 to 0.85 eV, and it is even more preferable to search for a catalytic metal having an oxygen atom adsorption energy of 0.30 to 0.60 eV.

In a third aspect, the present invention is an invention of an electrode catalyst specifically searched for by the above method of search for fuel-cell electrode catalysts. It is a fuel-cell electrode catalyst preferably containing a catalytic metal having an oxygen atom adsorption energy of 0.18 to 1.05 eV on the catalytic metal surface obtained through the molecular simulation analysis, more preferably containing a catalytic metal having an oxygen atom adsorption energy of 0.20 to 0.85 eV on the catalytic metal surface, and even more preferably containing a catalytic metal having an oxygen atom adsorption energy of 0.30 to 0.60 eV on the catalytic metal surface obtained through the molecular simulation analysis.

A more specific fuel-cell electrode catalyst of the present invention is a fuel-cell electrode catalyst composed of carbon on which an alloy containing platinum and gold is supported, and it is a fuel-cell electrode catalyst containing a catalytic metal expressed by Pt—Au or Pt—B—Au (B refers to a transition metal). As the transition metal, one or more kinds selected from the group consisting of chrome (Cr), manganese (Mn), iron (Fe), cobalt (Co), nickel (Ni), rhodium (Rh), and palladium (Pd) are preferably exemplified. The catalytic metal expressed by Pt—Au or Pt—B—Au (B refers to a transition metal) is especially excellent in catalytic activity when the content of gold (Au) is 6 atom % or less with respect to the total amount of the catalytic metal alloy.

In the fuel-cell electrode catalyst of the present invention, it is preferable that the average particle size of catalytic metal particles is 3 to 20 nm, more preferably 3 to 15 nm.

In a fourth aspect, the present invention is a fuel cell utilizing the above electrode catalyst. Specifically, the fuel cell of the present invention is a polymer electrolyte fuel cell composed of an anode, a cathode, and a polymer electrolyte membrane disposed between the anode and the cathode. The electrode catalyst includes a catalytic metal having an oxygen atom adsorption energy of 0.18 to 1.05 eV on the catalytic metal surface obtained through the molecular simulation analysis, more preferably it includes a catalytic metal having an oxygen atom adsorption energy of 0.20 to 0.85 eV on the catalytic metal surface, and even more preferably it includes a catalytic metal having an oxygen atom adsorption energy of 0.30 to 0.60 eV on the catalytic metal surface obtained through the molecular simulation analysis.

The fuel cell of the present invention is composed of a tabular unit cell and two separators disposed on both sides of the unit cell. In such fuel cell, by using the above electrode catalyst, the electrode reactions expressed by formulas (1) and (2) proceed in the anode and the cathode, respectively, and the entire cell reaction expressed by formula (3) proceeds as a whole, whereby electromotive force is generated.

Thus, since such electrode catalyst having high catalytic activity is used, the fuel cell of the present invention is excellent in power generation performance.

### EFFECT OF THE INVENTION

In accordance with the present invention, by using oxygen atom adsorption energy on the catalytic metal surface obtained through the molecular simulation analysis as an indicator of performance evaluation and search for a new catalyst, a high-performance fuel-cell electrode catalyst can be accurately evaluated and searched for. Thus, labor and time for evaluating the performance of or searching for a fuel cell can be significantly reduced.

### BRIEF DESCRIPTION OF THE DRAWINGS

FIG. 1 shows the correlation between catalytic activity and oxygen atom adsorption energy. The figure shows the correlation between the measured performance (catalytic activity (oxygen reduction current) obtained by an RDE (rotating disk electrode) evaluation method) of various catalytic metal compositions disclosed in the above Non-patent Document 1, and oxygen atom adsorption energy.

FIG. 2 shows the correlation between catalytic activity and oxygen atom adsorption energy, to which the catalytic activity and oxygen atom adsorption energy of Pt—Au and Pt—Co—Au searched for by the present inventors are added, in addition to data in FIG. 1.

### BEST MODES OF CARRYING OUT THE INVENTION

An example of the present invention will be hereafter described in detail.

A publicly known carbon material can be used for a conductive carrier used in a fuel-cell electrode catalyst of the present invention. Particularly, carbon black, such as channel black, furnace black, thermal black, or acetylene black, or activated carbon is preferably exemplified.

In cases in which the electrode catalyst of the present invention is used in a polymer electrolyte fuel cell, either a fluorine-system electrolyte or a hydrocarbon-system electrolyte can be used as a polymer electrolyte. The fluorine-system polymer electrolyte is formed by introducing an electrolyte group, such as a sulfonic acid group or a carboxylic acid group, to a fluorine-system high polymer. The fluorine-system polymer electrolyte used in the fuel cell of the present invention refers to a polymer in which an electrolyte group as a substituent, such as a sulfonic acid group, is introduced to a fluorocarbon skeleton or a hydrofluorocarbon skeleton, and an ether group, chlorine, a carboxylic acid group, a phosphate group, an aromatic ring may be included in a molecule. Generally, a polymer having perfluorocarbon as the main chain skeleton and having a sulfonic acid group via a spacer, such as a perfluoroether or an aromatic ring, is used. Specifically, “Nafion” (registered trademark) manufactured by DuPont co. ltd., “Aciplex-S” (registered trademark) manufactured by Asahi Kasei Corp., and the like are known. The hydrocarbon system polymer electrolyte used in the fuel cell of the present invention includes a hydrocarbon portion in any of the molecular chains of which the high polymer is composed, and an electrolyte group is introduced thereto. Examples of the electrolyte group include a sulfonic acid group and a carboxylic acid group.

### Example

The present invention will be hereafter described in more detail based on an example.

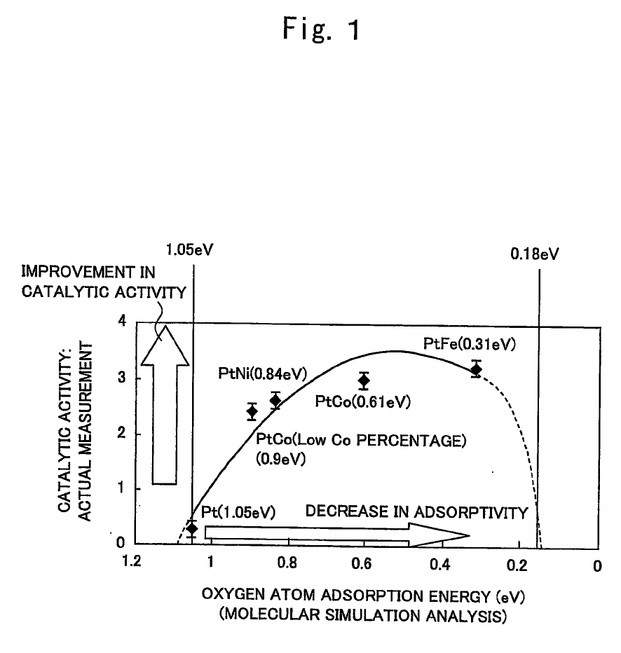

FIG. 1 shows the correlation between catalytic activity and oxygen atom adsorption energy. The horizontal axis represents the measured performance (catalytic activity (oxygen reduction current) obtained by an RDE (rotating disk electrode) evaluation method) of various catalytic metal compositions disclosed in the above Non-patent Document 1, and the horizontal axis represents the oxygen atom adsorption energy on the surfaces of the catalytic metals obtained through a molecular simulation analysis calculated by the present inventors.

Referring to results in FIG. 1, the catalytic activity and the oxygen atom adsorption energy on the catalytic metal surfaces obtained through the molecular simulation analysis plot a volcano plot, indicating a clear correlation between them.

While not plotted in FIG. 1, with regard to the oxygen atom adsorption energy of catalytic metals whose activity is lower than that of Pt catalyst (1.05 eV), such catalysts (metal catalysts that would be plotted on the left side of the graph) that do not show activity due to excessively large oxygen atom adsorption energy (eV) include Pd (1.89 eV), Ir (2.25 eV), Rh (1.69 eV), Os (2.99 eV), Ag (1.47 eV). Further, such catalysts (metal catalysts that would be plotted on the right side of the graph) that do not show activity due to excessively small oxygen atom adsorption energy (eV) include Au (0.15 eV).

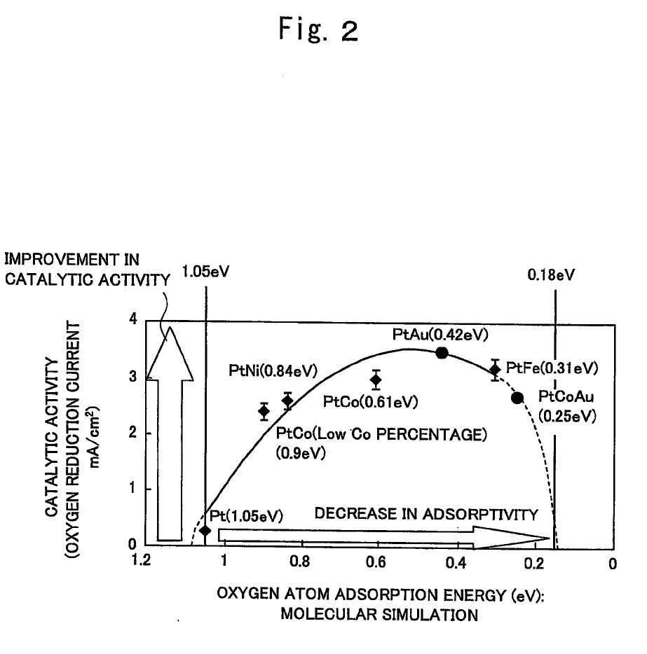

FIG. 2 shows the correlation between catalytic activity and oxygen atom adsorption energy, to which the catalytic activity and oxygen atom adsorption energy of Pt—Au and Pt—Co—Au searched for by the present inventors are added, in addition to data in FIG. 1. As seen from FIG. 2, Pt—Au (0.42 eV) and Pt—Co—Au (0.25 eV) are superior in catalytic activity.

### INDUSTRIAL APPLICABILITY

In accordance with the present invention, by using oxygen atom adsorption energy on the catalytic metal surface obtained through the molecular simulation analysis as an indicator of performance evaluation and search for a new catalyst, a high-performance fuel-cell electrode catalyst can be accurately evaluated and searched for. Thus, since labor and time for evaluating the performance of or searching for a fuel cell can be significantly reduced, the present invention contributes to the practical application and spread of fuel cells.

1. A method of evaluating the performance of a fuel-cell electrode catalyst comprising a conductive carrier on which catalytic metal is supported, wherein oxygen atom adsorption energy on the catalytic metal surface obtained through a molecular simulation analysis is used as an indicator of the performance evaluation.

2. The method of evaluating the performance of a fuel-cell electrode catalyst according to claim 1, wherein the catalytic metal is selected so that the oxygen atom adsorption energy is 0.18 to 1.05 eV.

3. A method of search for a fuel-cell electrode catalyst comprising a conductive carrier on which catalytic metal is supported, wherein oxygen atom adsorption energy on the catalytic metal surface obtained through a molecular simulation analysis is used as an indicator of the search.

4. The method of search for a fuel-cell electrode catalyst according to claim 3, wherein the catalytic metal having an oxygen atom adsorption energy of 0.18 to 1.05 eV is searched for.

5. A fuel-cell electrode catalyst comprising a conductive carrier on which catalytic metal is supported, wherein the catalyst contains such catalytic metal having an oxygen atom adsorption energy of 0.20 to 0.85 eV on the catalytic metal surface obtained through a molecular simulation analysis.

6. A fuel-cell electrode catalyst comprising a conductive carrier on which catalytic metal is supported, wherein the catalyst contains such catalytic metal having an oxygen atom adsorption energy of 0.30 to 0.60 eV on the catalytic metal surface obtained through a molecular simulation analysis.

7. A fuel-cell electrode catalyst comprising carbon on which an alloy containing platinum and gold is supported, wherein the catalyst contains such catalytic metal expressed by Pt—Au or Pt—B—Au (B refers to a transition metal).

8. The fuel-cell electrode catalyst according to claim 7, wherein the transition metal is one or more kinds selected from the group consisting of chrome (Cr), manganese (Mn), iron (Fe), cobalt (Co), nickel (Ni), rhodium (Rh), and palladium (Pd).

9. The fuel-cell electrode catalyst according to claim 7 or 8, wherein, in the catalytic metal expressed by Pt—Au or Pt—B—Au (B refers to a transition metal), the content of gold (Au) is 6 atom % or less with respect to the total amount of the catalytic metal alloy.

10. A fuel cell using the electrode catalyst according to any one of claims 5 to 9.
